(19) United States
(12) Patent Application Publication
(10) Pub. No.: US 2017/0286133 A1
(43) Pub. Date: Oct. 5, 2017

(54) One Step Task Completion

(71) Applicant: Microsoft Technology Licensing, LLC, Redmond, WA (US)

(72) Inventors: Amy Harilal Rambhia, Bellevue, WA (US); Robert J. Howard, III, Bellevue, WA (US); Joseph Spencer King, Seattle, WA (US)

(73) Assignee: Microsoft Technology Licensing, LLC, Redmond, WA (US)

(21) Appl. No.: 15/199,758

(22) Filed: Jun. 30, 2016

Related U.S. Application Data
(60) Provisional application No. 62/314,987, filed on Mar. 29, 2016.

(51) Int. Cl. G06F 9/44; G06F 17/30; G06F 17/27

(52) U.S. Cl. CPC G06F 9/4446; G06F 17/2705; G06F 17/30528; G06F 17/30867

(57) ABSTRACT

In embodiments of one step task completion, a computing system includes memory to maintain metadata associated with information that corresponds to a user, where the information is then determinable with a contextual search based on the metadata. The information corresponding to a user can be determined and tagged with the metadata, such as information associated with a user account and/or activity of the user. The computing system includes a personal assistant application that is implemented to receive a request as a one step directive to locate the information and perform an action designated for the information. The personal assistant application can then locate the information based on the metadata, and perform the action designated for the information.

### RELATED APPLICATION

This application claims priority to U.S. Provisional Application Ser. No. 62/314,987 filed Mar. 29, 2016 entitled “One Step Task Completion” to Rambhia et al., the disclosure of which is incorporated by reference herein in its entirety.

### BACKGROUND

Many device users have electronic and computing devices, such as desktop computers, laptop computers, mobile phones, tablet computers, multimedia devices, wearable devices, and other similar devices. These types of computing devices are utilized for many different computing applications, such as to compose email, surf the web, edit documents, interact with applications, interact on social media, and access other resources and documents. In a common interaction with a device, a user may develop and save a document, and then on a later day, send the document to a coworker, such as via an email message. Typically, the user will then need to manually complete multiple steps to send the document, such as initiate a new email message, address and compose the email message, search for and attach the previously saved document, and then send the email message to his or her coworker. Generally, a user will need to search for content, then parse, identify, and/or select the content, such as by opening the application that is associated with the content, followed by initiating an action selection in a context menu or opening a file in order to then complete the action.

### SUMMARY

This Summary introduces features and concepts of one step task completion, such as using natural language, which is further described below in the Detailed Description and/or shown in the Figures. This Summary should not be considered to describe essential features of the claimed subject matter, nor used to determine or limit the scope of the claimed subject matter.

One step task completion is described. In embodiments, a computing system includes memory to maintain metadata associated with information that corresponds to a user, where the information is then determinable with a contextual search based on the metadata. The information corresponding to a user can be determined and tagged with the metadata, such as information associated with a user account and/or activity of the user, and the metadata provides a context of the information for the contextual search. The computing system includes a personal assistant application that is implemented to receive a request as a one step directive to locate the information and perform an action designated for the information. The personal assistant application can then locate the information based on the metadata, and perform the action designated for the information.

In other aspects of one step task completion, the one step directive is a multi-part, single command in the format of “find+do”, having a first part to find the information and a second part to perform the designated action. The personal assistant application can receive the one step directive as a natural language input in any type of format, such as an audio format, a haptic format, a typed format, or a gesture format. The personal assistant application can then parse the natural language input to identify the requested information and the action to perform. The personal assistant application can also be implemented to confirm the action of the one step directive having been performed for the information. For example, a one step directive may be initiated to find a particular document and send it to a recipient. The personal assistant application can then find the document, attach it to an email, address the email to the recipient, and initiate sending the email. The confirmation may be in the form of the personal assistant application copying the user who initiates the one step directive on the email and/or the personal assistant application can receive an email delivered confirmation and forward the confirmation to the user.

In other aspects of one step task completion, the information that corresponds to the user may be search content entered in a browser application. The personal assistant application can then locate the search content and perform the action associated with the search content. For example, the information that is associated with the user may not be only tagged documents and/or files, but can be any type of searchable content, to include notebook entries, profile information, clicked items of interest, browser search content, and/or any other type of searchable content that has been tagged and is determinable with a contextual search.

In other aspects of one step task completion, the personal assistant application can be implemented as a cloud-based service application, which is accessible by request from a user client device. Further, the information that corresponds to the user may be maintained as third-party data, accessible from a social media site or a third-party data service based on a user account. The personal assistant application, implemented on a user client device or as an on-line application, can then access the social media site or the third-party data service utilizing the user account to locate the information, and access the information to perform the action designated for the information.

### BRIEF DESCRIPTION OF THE DRAWINGS

Embodiments of one step task completion are described with reference to the following Figures. The same numbers may be used throughout to reference like features and components that are shown in the Figures:

FIG. 1 illustrates an example system in which embodiments of one step task completion can be implemented.

FIG. 2 illustrates an example of information analytics in embodiments of one step task completion.

FIG. 3 illustrates an example personal digital assistant that utilizes the information analytics in embodiments of one step task completion.

FIG. 4 illustrates example method(s) of one step task completion in accordance with one or more embodiments.

FIG. 5 illustrates an example system with example devices that can implement embodiments of one step task completion.

FIGS. 6-17 illustrate example devices, systems, and methods of contextual search using natural language.

### DETAILED DESCRIPTION

Embodiments of one step task completion are described and can be implemented to respond to a user request, such as a natural language request that is received as a one step directive to locate information and perform an action associated with the information. A personal assistant application and/or system that implements a personal digital assistant can receive the natural language request, determine the information based on metadata that is associated with the information, and perform the action associated with the information. Multiple steps or actions can be completed based on a single request received as a one step directive, such as a single statement to search for a document or other information and then perform an action as designated in the directive.

For example, a user may state a one step directive in natural language to “send the presentation I was editing yesterday to my assistant.” A computing system, such as a mobile phone, tablet device, office computer, etc. can receive and process the voice command. A personal assistant application that is implemented on the device or cloud-based can receive the request as the one step directive and, based on metadata, locate the presentation that was edited yesterday, determine the assistant, initiate an email message with the presentation attached to the assistant, and send the email message. Other examples of one step directives in a “locate and perform an action” format (also referred to as “find+do”) may be natural language statements to “project the spreadsheet that I was reviewing this weekend on the screen in this meeting room,” or “start a slideshow of the Hawaii trip pictures on the gaming console.” Note that a one step directive may be related to an activity by a user, such as having edited the presentation or reviewed the spreadsheet, or may be related by a user account or other identifying information, such as if a user indicates to “go and ‘like’ the photos that my spouse has posted on a social media site.”

In this example, the user may not have even accessed or viewed the photos, yet by having an associated user account with the social media site, can initiate the one step directive in natural language. Other similar examples may include a directive to “play a funny video from a video sharing site.” or a one step directive to “project the presentation document that my boss just sent me in this meeting room.” In this instance, the user may have received an email with an attachment of the presentation document, but has not yet viewed the document. However, the system associates the presentation document with the user because the document was received in the user's email.

The content can be any information associated with a user, such as personal content or documents that the user owns or has access to. The actions can be those that are often found in context menus, or other actions provided by various applications and services. Embodiments of one step task completion allows a user to streamline the process with a simple and straightforward natural language commanding system. The personal assistant application, agent, or system can then search and execute the action on behalf of the user, and the user will come to trust the personal assistant to have performed the requested action on the correct document or information. A sense of trust in the system can be instilled using feedback that may include a preview of a document or file that has been communicated via an email message, initiating a confirmation step prior to sending an email message, automatically copying the user on outgoing email messages, and the like. This may be a user-selectable option to activate or deactivate.

A contextually aware digital assistant supported on devices such as smartphones, tablet computers, wearable computing devices, personal computers (PCs), game consoles, smart place-based devices, vehicles, and the like is implemented with a natural language interface that enables a user to launch searches for content using contextual references such as time, date, event, location, schedule, activity, contacts, or device. The user can thus use natural language to express the context that is applicable to the sought-after content rather than having to formulate a query that uses a specific syntax. The digital assistant can comprehensively search for the content across applications (i.e., both first and third party applications), devices, and services, or any combination of the three.

Accordingly, when using a device, the user can ask the digital assistant to search for particular content simply by specifying the context to be used as search criteria. For example, the user can ask the digital assistant to find the documents worked on earlier in the week using a tablet device when on the subway with a friend. The digital assistant can initiate a search in response to the user's natural language request and provide the comprehensive results to the user in a single, integrated user interface (UI) such as a canvas supported by the digital assistant or operating system running on the device. The user may select content from the search results which the digital assistant can render on the local device and/or download from a remote device and/or service.

Initiating contextual searches using the digital assistant improves the user experience by letting users formulate search queries in a flexible, intuitive, or natural manner that forgoes rigid syntactical rules. By using context when searching, the digital assistant can provide results that can be expected to be more nuanced, meaningful, comprehensive, and relevant to the user as compared to traditional search methods. In addition, by extending the search across applications, devices, and services and then consolidating the results, the digital assistant provides an easy and effective way for users to find, access, and manage their content from a single place on a device UI. The context aware digital assistant increases user efficiency when interacting with the device by enabling the user to quickly and accurately locate particular content from a variety of sources, services, applications, and locations.

A computing device and/or cloud-based personal assistant application can be implemented as a component or part of a natural language understanding (NLU) system that is implemented, and has the ability, to locate or determine content based on natural language inputs, such as to understand user intent that combines a “find+do” one step directive. The NLU system is robust and “understands” (e.g., can determine) utterances and variations in query form, and includes support for data types, improving on the language understanding models to support more contextual properties on the data. For example, a user may indicate any one of “find the document that I edited/presented/shared/projected/reviewed/printed yesterday.” Additionally, the NLU system can be implemented to support directives found in context menus, as well as application enabled actions or system actions on user content. For example, a user may indicate any one of “print the file,” “share the file,” “send the file to someone,” “project the file,” “queue the music,” “play video to the gaming console,” and the like. Additionally, the NLU system can be implemented to train itself to understand the combined improvements, allowing users to execute the entire find+do flow with a single natural language command.

The NLU system can include content tagging components, generators, applications and the like to tag information that corresponds to a user with metadata, so that the information is then determinable with a contextual search based on the metadata (e.g., the information can be identified automatically using a contextual search). A client-side and/or server-side (e.g., cloud-based) tagging component, generator, application, etc. can maintain the information and content that is associated with a user, such as location, events on a calendar at the same time, people that the user works with, an action that the user performed on the content, etc. The tagging of the information with the metadata can be performed by the system overall and/or by each participating application or service. A user can then utilize the contextual information to recollect their content of choice, where the contextual recollection is needed for a search result to be precise and accurate, without having to resort to a disambiguation user interface that requires the user to choose the content designated in a one step directive (e.g., complete actions on search results automatically in the background without a user interface input from the user).

The information associated with a user may include a user account, content and documents of the user, storage drives associated with the user, other data stores, any content, document, or searching activity associated with the user, social media interactions, third-party content access or interactions, any type of indexed data sources, content from applications, Web services, and/or any other type of user information and activity associated with use of a computing or electronic device. The system can be implemented to support searching for information that is associated with a user on a local indexer, on a cloud-based storage drive, based on Web history, cloud-based, online application services, and associated with third-party services. Other data, content, and information sources can include plugged-in USB drives, NAS drives, and a user's personal profile with the personal assistant application. The NLU system can be implemented to support using natural language across context menus, web services, and other application extensibility frameworks, such as VCD (voice command definition file).

While features and concepts of one step task completion can be implemented in any number of different devices, systems, networks, environments, and/or configurations, embodiments of one step task completion are described in the context of the following example devices, systems, and methods.

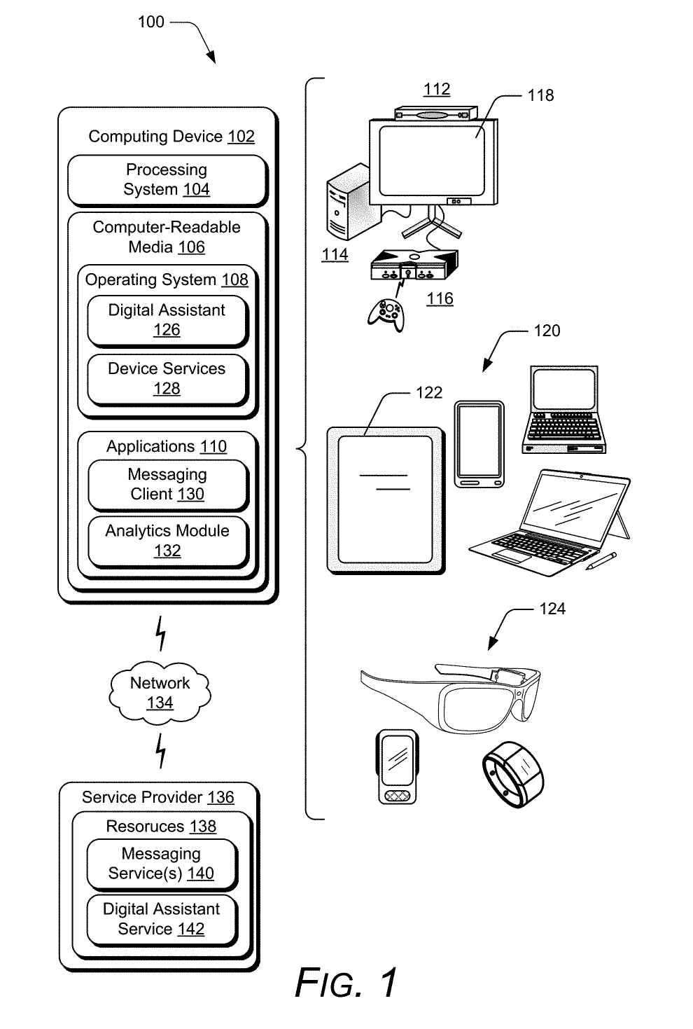

FIG. 1 illustrates an example system 100 in which embodiments of one step task completion can be implemented. The example system 100 includes a computing device 102 having a processing system 104 with one or more processors and devices (e.g., CPUs, GPUs, microcontrollers, hardware elements, fixed logic devices, etc.), one or more computer-readable media 106, an operating system 108, and one or more applications 110 that reside on the computer-readable media and which are executable by the processing system. The processing system 104 may retrieve and execute computer-program instructions from applications 110 to provide a wide range of functionality to the computing device 102, including but not limited to gaming, office productivity, email, media management, printing, networking, web-browsing, and so forth. A variety of data and program files related to the applications 110 can also be included, examples of which include games files, office documents, multimedia files, emails, data files, web pages, user profile and/or preference data, and so forth.

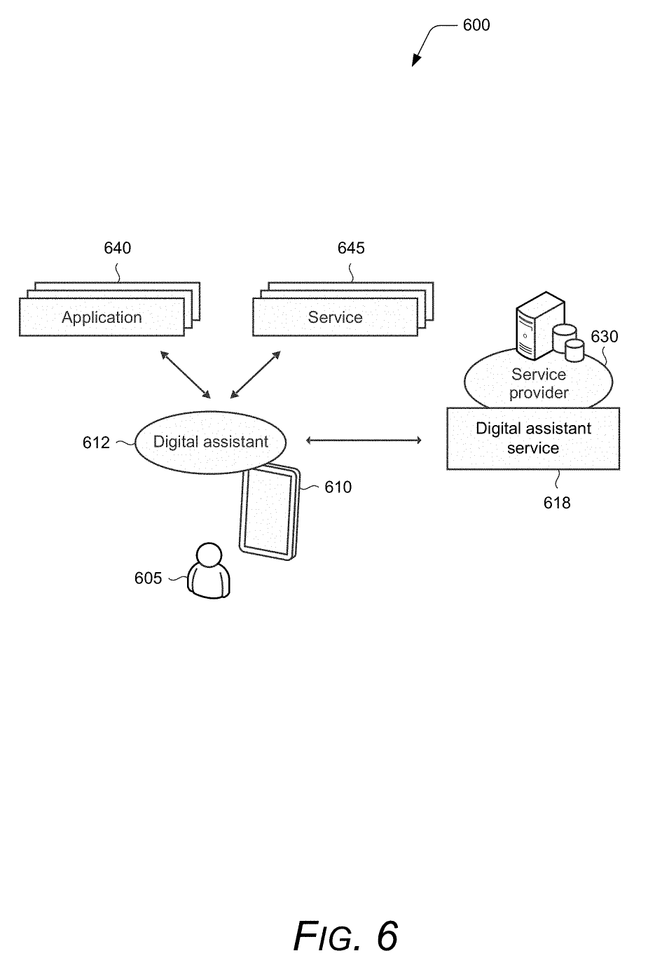

The computing device 102 can be embodied as any suitable computing system and/or device such as, by way of example and not limitation, a gaming system, a desktop computer, a portable computer, a tablet or slate computer, a handheld computer such as a personal digital assistant (PDA), a cell phone, a set-top box, a wearable device (e.g., watch, band, glasses, etc.), and the like. For example, as shown in FIG. 1 the computing device 102 can be implemented as a television client device 112, a computer 114, and/or a gaming system 116 that is connected to a display device 118 to display media content. Alternatively, the computing device may be any type of portable computer, mobile phone, or portable device 120 that includes an integrated display 122. A computing device may also be configured as a wearable device 124 that is designed to be worn by, attached to, carried by, or otherwise transported by a user. Examples of wearable devices 124 depicted in FIG. 1 include glasses, a smart band or watch, and a pod device such as clip-on fitness device, media player, or tracker. Other examples of wearable devices 124 include but are not limited to a ring, an article of clothing, a glove, and a bracelet, to name a few examples. Any of the computing devices can be implemented with various components, such as one or more processors and memory devices, as well as with any combination of differing components. One example of a computing system that can represent various systems and/or devices including the computing device 102 is shown and described below in relation to FIG. 5.

The computing device 102 may include or make use of a digital assistant 126 (also referred to herein as a personal assistant, a personal assistant application, or a personal digital assistant). In the illustrated example, the digital assistant 126 is depicted as being integrated with the operating system 108. The digital assistant 126 may alternatively be implemented as a stand-alone application, or a component of a different application such as a browser or messaging client application. The digital assistant 126 represents functionality operable to perform requested tasks, provide requested advice and information, and/or invoke various device services 128 to complete requested actions. The digital assistant may utilize natural language processing, a knowledge database, and artificial intelligence implemented by the system to interpret and respond to requests in various forms.

For example, requests may include spoken or written (e.g., typed text) data that is interpreted through natural language processing capabilities of the digital assistant. The digital assistant may interpret various input and contextual clues to infer the user's intent, translate the inferred intent into actionable tasks and parameters, and then execute operations and deploy device services 128 to perform the tasks. Thus, the digital assistant 126 is designed to act on behalf of a user to produce outputs that fulfill the user's intent as expressed during natural language interactions between the user and the digital assistant. The digital assistant 126 may be implemented using a client-server model with at least some aspects being provided via a digital assistant service component as discussed below.

In accordance with techniques described herein, the digital assistant 126 includes or makes use of functionality for processing and handling of one step directives to infer corresponding user intent and take appropriate actions for task completion, device operations, and so forth in response to the one step directives. Functionality for processing and handling of one step directives may be implemented in connection with a messaging client 130 and an analytics module 132. The messaging client 130 represents functionality to enable various kinds of communications over a network including but not limited to email, instant messaging, voice communications, text messaging, chats, and so forth. The messaging client 130 may represent multiple separate desktop or device applications employed for different types of communications. The messaging client 130 may also represent functionality of a browser or other suitable application to access web-based messaging accounts via available from a service provider over a network.

The analytics module 132 represents functionality to implement techniques for commanding and task completion through one step directives as described herein. The analytics module 132 may be implemented as a stand-alone application as illustrated. In this case, the digital assistant 126, messaging client 130, and other applications 110 may invoke the analytics module 132 to perform operations for analysis of one step directives. Alternatively, the analytics module 132 may be implemented as an integrated component of the operating system 108, digital assistant 126, messaging client 130, or other application/service. Generally, the analytics module 132 is operable to check one step directives and messages associated with a user account and determine information that corresponds to a user, the information being determinable with a contextual search based on metadata. The analytics module 132 can further analyze content and one step directives to derive the intent of the user in initiating a natural language one step directive. The analytics module 132 can associate tags with user information indicative of categories into which the user information is classified. The analytics module 132 can cause performance of one step directives and actions based on classification of information in various ways. Functionality to trigger actions may be included as part of the analytics module 132. In addition or alternatively, the analytics module 132 may be configured to invoke and interact with the digital assistant 126 to initiate performance of one step directives and actions through functionality implemented by the digital assistant 126.

The example system 100 is an environment that further depicts the computing device 102 may be communicatively coupled via a network 134 to a service provider 136, which enables the computing device 102 to access and interact with various resources 138 made available by the service provider 136. The resources 138 can include any suitable combination of content and/or services typically made available over a network by one or more service providers. For instance, content can include various combinations of text, video, ads, audio, multi-media streams, animations, images, webpages, and the like. Some examples of services include, but are not limited to, an online computing service (e.g., “cloud” computing), an authentication service, web-based applications, a file storage and collaboration service, a search service, messaging services 140 such as email, text and/or instant messaging, and a social networking service.

Services may also include a digital assistant service 142, which represents server-side components of a digital assistant system that operates in conjunction with client-side components represented by the digital assistant 126. The digital assistant service 142 enables digital assistant clients to plug-in to various resources 138 such as search services, analytics, community-based knowledge, and so forth. The digital assistant service 142 can also populate updates across digital assistant client applications, such as to update natural language processing and keep a knowledge database up-to-date.

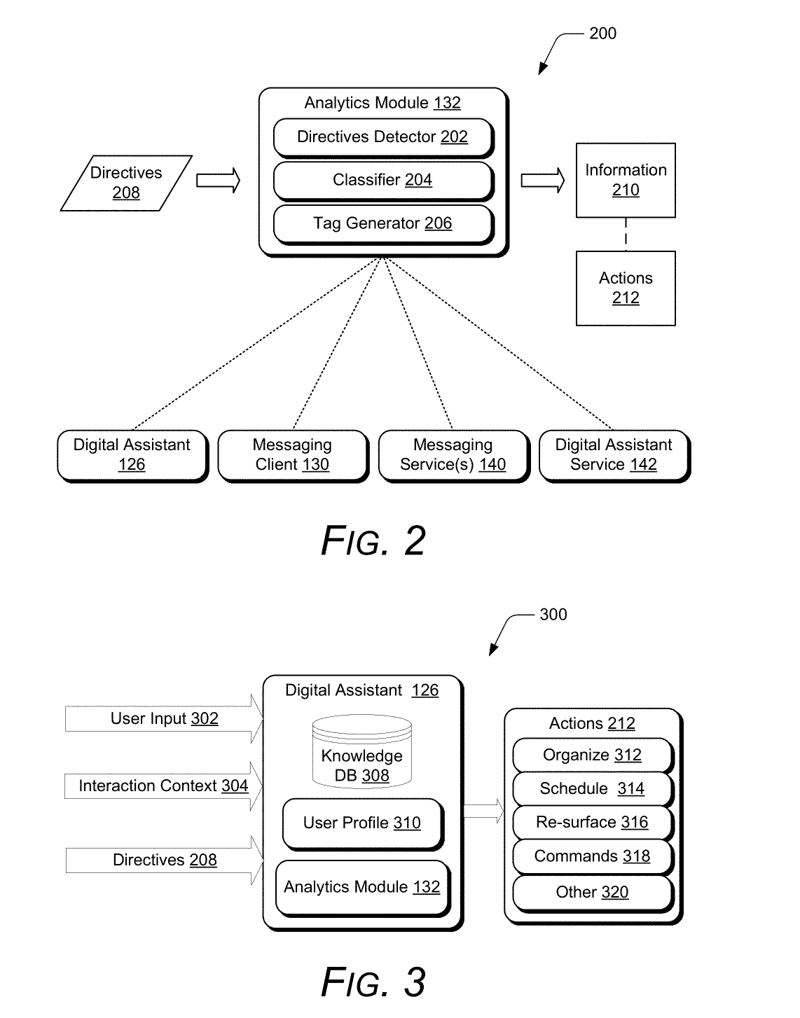

FIG. 2 illustrates an example 200 of information analytics in embodiments of one step task completion. The analytics module 132 may be implemented as a component of various applications, examples of which include the digital assistant 126, messaging client 130, messaging service 140, or digital assistant service 142 as represented in FIG. 2. The analytics module 132 may also be implemented as a stand-alone application as represented in FIG. 1. As noted, the analytics module 132 is generally operable to check one step directives associated with a user and/or user account and recognize “find+do” one step directives initiated by the user in a natural language. The analytics module 132 may include a directives detector 202, a classifier 204, and a tag generator 206.

The directives detector 202 performs processing to check one step directives 208 and identify the information and actions of the one step directives. The classifier 204 operates to perform further processing and represents functionality to analyze the one step directives to infer intent of the user. In other words, the classifier 204 attempts to determine what the user was intending, and parses message content and metadata to detect the intent of a directive. This analysis may include natural language processing to understand the intent, and extract words as commands and tags indicated by the content of the one step directive. The classifier 204 can then determine the information 210 and the actions 212 to perform with the information.

The tag generator 206 represents functionality to create and assign tags indicative of the information classifications and related content. The tag generator 206 updates metadata associated with information 210. The tags may also include information such as relevant dates, locations, names, links, commands, action words, and so forth. The tagged information facilitates automatic detection of task/actions for the one step directives 208 and completion of the task/actions. The tags also enable resurfacing of the information based on context at appropriate times, such as when the user initiates a one step directive in natural language.

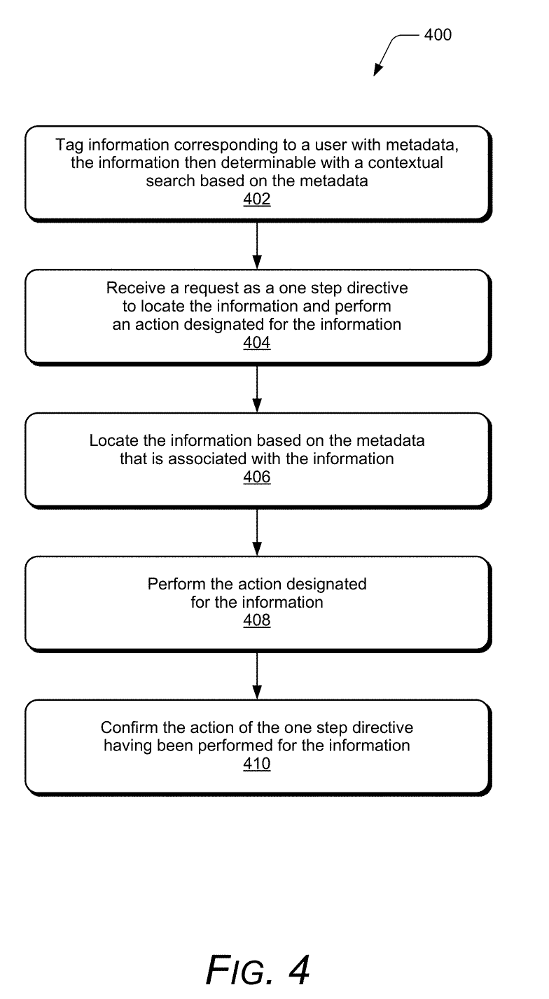

FIG. 3 illustrates an example 300 of the personal digital assistant 126 (e.g., a personal assistant application) that utilizes the information analytics in embodiments of one step task completion. For example, a digital assistant 126 may be designed to implement processing and handling of one step directives to infer corresponding user intent and take appropriate actions for task completion, device operations, and so forth in response to the one step directives. In one or more implementations, the digital assistant 126 includes or makes use of a analytics module 132 as described herein.

To process the one step directives 208, as well as other requests, the digital assistant 126 may rely upon user input 302 as well as information regarding the current interaction context 304. The one step directives 208 are initiated by a user in natural language, and processing of the directives as described herein can occur on the device-side and/or on the server-side for web accessible information. The digital assistant 126 may further rely upon a knowledge database 308 and user profile 310. The knowledge database 308 represents a dynamic repository of information that may be employed for searches, to find answers to questions, to facilitate natural language processing, and otherwise enable features of the digital assistant 126. Knowledge database 308 can be referenced during classification of information to determine actions to take for different classes of information and content. The user profile 310 represents the user's particular settings, preferences, behaviors, interests, contacts, and so forth. The user profile 310 may include settings and preferences for handling of self-messages in accordance with the techniques discussed herein.

In operation, the digital assistant 126 obtains the one step directives 208 and processes the directives via the analytics module 132, and the one step directives may be informed by the user input 302, interaction context 304, knowledge database 308, and user profile 310. The information can be tagged in accordance with the classifications to generate information 210 as discussed in relation to FIG. 2. The digital assistant 126 through the analytics module 132 further operates to assign actions 212 to the information 210, and the actions 212 are designed to implement tasks and commands to carry the inferred user intent of the one step directives. For example, if information is classified as indicating an appointment, the digital assistant 126 can assign and perform an action related to the information. FIG. 3 represents some illustrative example types of actions 212 that may be performed responsive to detection of one step directives, such as actions to organize 312 information, schedule 314, re-surface 316 the information, commands 318, and other actions 320.

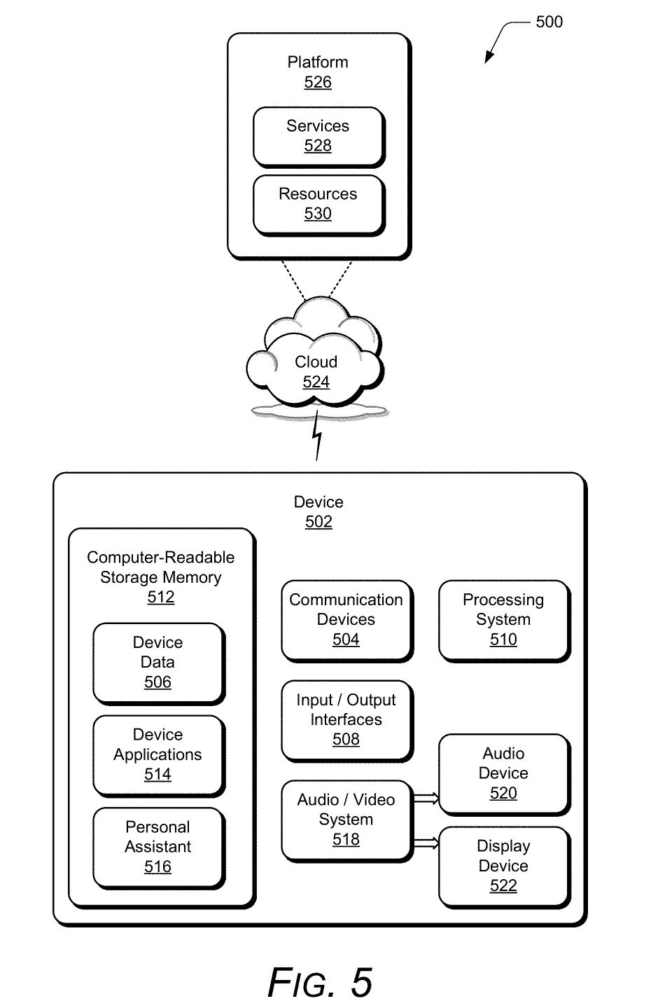

Example method 400 is described with reference to FIG. 4 in accordance with one or more embodiments of one step task completion. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 4 illustrates example method(s) 400 of one step task completion. The order in which the method is described is not intended to be construed as a limitation, and any number or combination of the method operations can be performed in any order to implement a method, or an alternate method.

At 402, information corresponding to a user is tagged with metadata, the information then determinable with a contextual search based on the metadata. For example, the analytics module 132 tags information corresponding to a user with metadata, and the information is then determinable with a contextual search based on the metadata.

At 404, a request is received as a one step directive to locate the information and perform an action designated for the information. For example, the personal assistant application (e.g., the digital assistant 126) receives a request as a one step directive to locate the information and perform an action designated for the information. The one step directive is a multi-part, single command having a first part to find the information and a second part to perform the action. The one step directive can be received as a natural language input in any one of an audio format, a haptic format, a typed format, or a gesture format, and the personal assistant application parses the natural language input to identify the requested information and the action to perform.

At 406, the information is located based on the metadata that is associated with the information. For example, the personal assistant application (e.g., the digital assistant 126) locates the information based on the metadata that is associated with the information. The information may be search content entered in a browser application, and the personal assistant application locates the search content and performs an action associated with the search content. The information may also be maintained as third-party data, accessible from a social media site or a third-party data service based on a user account. The personal assistant application, implemented on a user client device or as an on-line application, can then access the social media site or the third-party data service utilizing the user account to locate the information, and access the information to perform the action designated for the information.

At 408, the action designated for the information is performed. For example, the personal assistant application (e.g., the digital assistant 126) performs the action that is designated for the information. At 410, the action of the one step directive is confirmed as having been performed for the information. For example, the personal assistant application (e.g., the digital assistant 126) confirms the action of the one step directive as having been performed for the information.

FIG. 5 illustrates an example system 500 that includes an example device 502, which can implement embodiments of one step task completion. The example device 502 can be implemented as any of the computing devices, user devices, and server devices described with reference to the previous FIGS. 1-4, such as any type of mobile device, wearable device, client device, mobile phone, tablet, computing, communication, entertainment, gaming, media playback, and/or other type of device.

The device 502 includes communication devices 504 that enable wired and/or wireless communication of device data 506, such as user information and one step directives. Additionally, the device data can include any type of audio, video, and/or image data. The communication devices 504 can also include transceivers for cellular phone communication and for network data communication.

The device 502 also includes input/output (I/O) interfaces 508, such as data network interfaces that provide connection and/or communication links between the device, data networks, other devices, and the vehicles described herein. The I/O interfaces can be used to couple the device to any type of components, peripherals, and/or accessory devices. The I/O interfaces also include data input ports via which any type of data, media content, and/or inputs can be received, such as user inputs to the device, as well as any type of audio, video, and/or image data received from any content and/or data source.

The device 502 includes a processing system 510 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 502 may further include any type of a system bus or other data and command transfer system that couples the various components within the device. A system bus can include any one or combination of different bus structures and architectures, as well as control and data lines.

The device 502 also includes a computer-readable storage memory 512, such as data storage devices that can be accessed by a computing device, and that provide persistent storage of data and executable instructions (e.g., software applications, programs, functions, and the like). Examples of the computer-readable storage memory 512 include volatile memory and non-volatile memory, fixed and removable media devices, and any suitable memory device or electronic data storage that maintains data for computing device access. The computer-readable storage memory can include various implementations of random access memory (RAM) (e.g., the DRAM and battery-backed RAM), read-only memory (ROM), flash memory, and other types of storage media in various memory device configurations.

The computer-readable storage memory 512 provides storage of the device data 506 and various device applications 514, such as an operating system that is maintained as a software application with the computer-readable storage memory and executed by the processing system 510. In this example, the device applications include a personal assistant 516 (e.g., a personal assistant application) that implements embodiments of one step task completion, such as when the example device 502 is implemented as a device as described with reference to FIGS. 1-4.

The device 502 also includes an audio and/or video system 518 that generates audio data for an audio device 520 and/or generates display data for a display device 522. The audio device and/or the display device include any devices that process, display, and/or otherwise render audio, video, display, and/or image data. In implementations, the audio device and/or the display device are integrated components of the example device 502. Alternatively, the audio device and/or the display device are external, peripheral components to the example device.

In embodiments, at least part of the techniques described for one step task completion may be implemented in a distributed system, such as over a “cloud” 524 in a platform 526. The cloud 524 includes and/or is representative of the platform 526 for services 528 and/or resources 530. The platform 526 abstracts underlying functionality of hardware, such as server devices (e.g., included in the services 528) and/or software resources (e.g., included as the resources 530), and connects the example device 502 with other devices, servers, vehicles 532, etc. The resources 530 may also include applications and/or data that can be utilized while computer processing is executed on servers that are remote from the example device 502. Additionally, the services 528 and/or the resources 530 may facilitate subscriber network services, such as over the Internet, a cellular network, or Wi-Fi network. The platform 526 may also serve to abstract and scale resources to service a demand for the resources 530 that are implemented via the platform, such as in an interconnected device embodiment with functionality distributed throughout the system 500. For example, the functionality may be implemented in part at the example device 502 as well as via the platform 526 that abstracts the functionality of the cloud.

FIGS. 6-17 illustrate example devices, systems, and methods of contextual search using natural language, which may be utilized to implement embodiments of one step task completion as described herein.

FIG. 6 shows an overview of an illustrative communications environment 600 for implementing a contextual search using natural language in which a user 605 employs a device 610 that hosts a digital assistant 612. The digital assistant 612 typically interoperates with a service 618 supported by a remote service provider 630. The digital assistant 612 is configured to enable interaction with applications 640 and services 645. The applications can include first-party and third-party applications in some cases. The services 645 can be provided by remote service providers that can interact with local clients and/or applications.

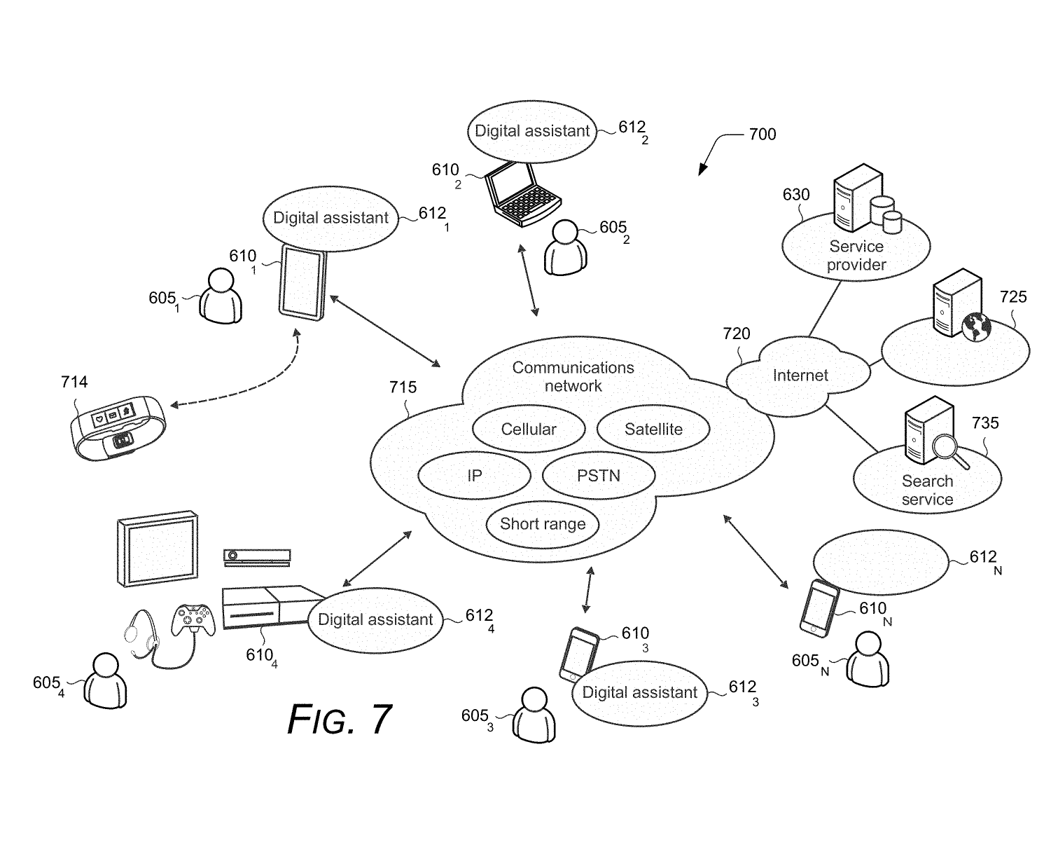

Various details of illustrative implementations of contextual search using natural language are shown. FIG. 7 shows an illustrative environment 700 in which various users 605 employ respective devices 610 that communicate over a communications network 715. Each device 610 includes an instance of the digital assistant 612. The devices 610 can support voice telephony capabilities in some cases and typically support data-consuming applications such as Internet browsing and multimedia (e.g., music or video) consumption in addition to various other features. The devices 610 may include, for example, user equipment, mobile phones, cell phones, feature phones, tablet computers, and smartphones which users often employ to make and receive voice and/or multimedia (i.e., video) calls, engage in messaging (e.g., texting) and email communications, use applications and access services that employ data, browse the World Wide Web, and the like.

However, alternative types of electronic devices are also envisioned to be usable within the communications environment 600 so long as they are configured with communication capabilities and can connect to the communications network 715. Such alternative devices variously include handheld computing devices, PDAs (personal digital assistants), portable media players, devices that use headsets and earphones (e.g., Bluetooth-compatible devices), phablet devices (i.e., combination smartphone/tablet devices), wearable computing devices, head mounted display (HMD) systems, navigation devices such as GPS (Global Positioning System) systems, laptop PCs (personal computers), desktop computers, computing platforms installed in cars and other vehicles, embedded systems (e.g., those installed in homes or offices), multimedia consoles, gaming systems, or the like. In the discussion that follows, the use of the term “device” is intended to cover all devices that are configured with communication capabilities and are capable of connectivity to the communications network 615. In some cases, a given device can communicate through a second device, or by using capabilities supported in the second device, in order to gain access to one or more of applications, services, or content.

The various devices 610 in the environment 700 can support different features, functionalities, and capabilities (here referred to generally as “features”). Some of the features supported on a given device can be similar to those supported on others, while other features may be unique to a given device. The degree of overlap and/or distinctiveness among features supported on the various devices 610 can vary by implementation. For example, some devices 610 can support touch controls, gesture recognition, and voice commands, while others may enable a more limited UI. Some devices may support video consumption and Internet browsing, while other devices may support more limited media handling and network interface features.

As shown, the devices 610 can access a communications network 715 in order to implement various user experiences. The communications network can include any of a variety of network types and network infrastructure in various combinations or sub-combinations including cellular networks, satellite networks, IP (Internet-Protocol) networks such as Wi-Fi and Ethernet networks, a public switched telephone network (PSTN), and/or short range networks such as Bluetooth® networks. The network infrastructure can be supported, for example, by mobile operators, enterprises, Internet service providers (ISPs), telephone service providers, data service providers, and the like. The communications network 715 typically includes interfaces that support a connection to the Internet 720 so that the mobile devices 610 can access content provided by one or more content providers 725 and also access the service provider 630 in some cases. A search service 735 may also be supported in the environment 700.

The communications network 715 is typically enabled to support various types of device-to-device communications including over-the-top communications, and communications that do not utilize conventional telephone numbers in order to provide connectivity between parties. Accessory devices 714, such as wristbands and other wearable devices may also be present in the environment 700. Such an accessory device 714 is typically adapted to interoperate with a device 610 using a short range communication protocol like Bluetooth to support functions such as monitoring of the wearer's physiology (e.g., heart rate, steps taken, calories burned) and environmental conditions (temperature, humidity, ultra-violet (UV) levels), and surfacing notifications from the coupled device 610.

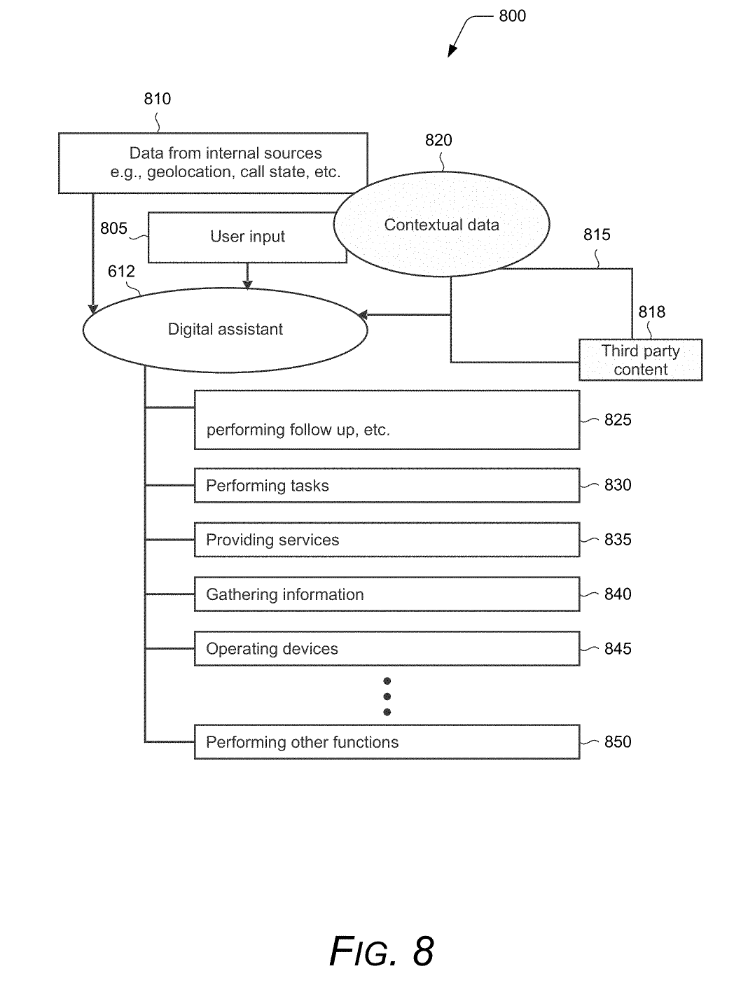

FIG. 8 shows an illustrative taxonomy of functions 800 that may typically be supported by the digital assistant 612 either natively or in combination with an application 640 or service 645. Inputs to the digital assistant 612 typically can include user input 805, data from internal sources 810, and data from external sources 815 which can include third-party content 318. For example, data from internal sources 810 could include the current location of the device 610 that is reported by a GPS (Global Positioning System) component on the device, or some other location-aware component. The externally sourced data 815 includes data provided, for example, by external systems, databases, services, and the like such as the service provider 630 (FIG. 6).

The various inputs can be used alone or in various combinations to enable the digital assistant 612 to utilize contextual data 820 when it operates. Contextual data can include, for example, time/date, the user's location, language, schedule, applications installed on the device, the user's preferences, the user's behaviors (in which such behaviors are monitored/tracked with notice to the user and the user's consent), stored contacts (including, in some cases, links to a local user's or remote user's social graph such as those maintained by external social networking services), call history, messaging history, browsing history, device type, device capabilities, communication network type and/or features/functionalities provided therein, mobile data plan restrictions/limitations, data associated with other parties to a communication (e.g., their schedules, preferences), and the like.

As shown, the functions 800 illustratively include interacting with the user 825 (through the natural language UI and other graphical UIs, for example); performing tasks 830 (e.g., making note of appointments in the user's calendar, sending messages and emails); providing services 835 (e.g., answering questions from the user, mapping directions to a destination, setting alarms, forwarding notifications, reading emails, news, blogs); gathering information 840 (e.g., finding information requested by the user about a book or movie, locating the nearest Italian restaurant); operating devices 845 (e.g., setting preferences, adjusting screen brightness, turning wireless connections such as Wi-Fi and Bluetooth on and off, communicating with other devices, controlling smart appliances); and performing various other functions 850. The list of functions 800 is not intended to be exhaustive and other functions may be provided by the digital assistant 612 and/or applications 640 as may be needed for a particular implementation of the present contextual search using natural language.

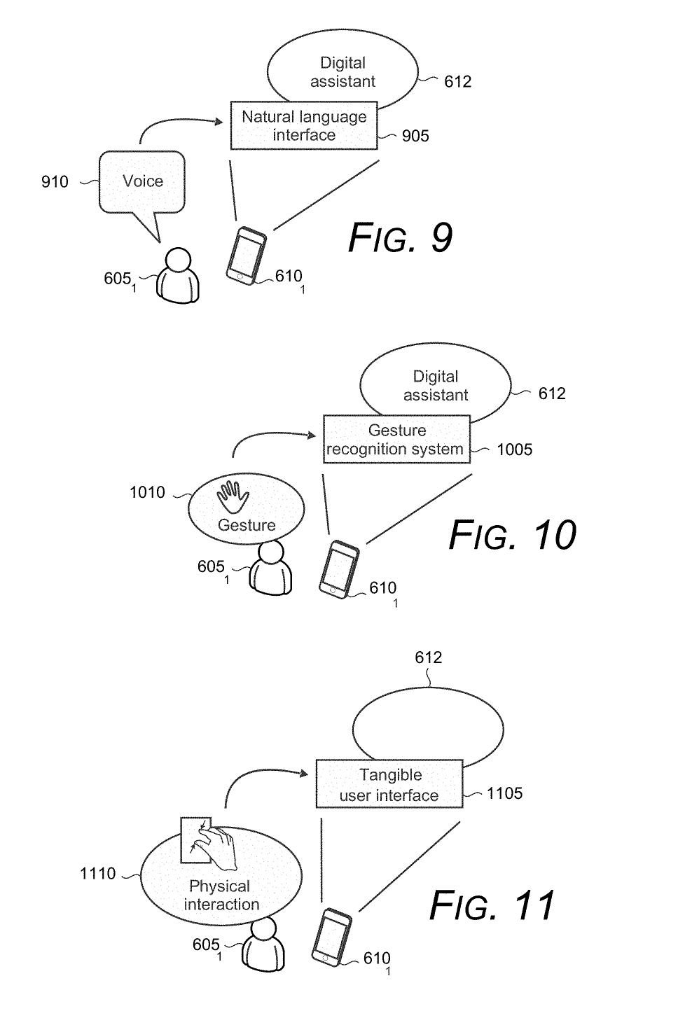

As shown in FIG. 9, the digital assistant 612 can employ a natural language interface 905 that has a user interface (UI) that can take voice inputs 910 from the user 605. The voice inputs 910 can be used to invoke various actions, features, and functions on a device 610, provide inputs to the systems and applications, and the like. In some cases, the voice inputs 910 can be utilized on their own in support of a particular user experience while in other cases the voice input can be utilized in combination with other non-voice inputs or inputs such as those implementing physical controls on the device or virtual controls implemented on a UI or those using gestures (as described below).

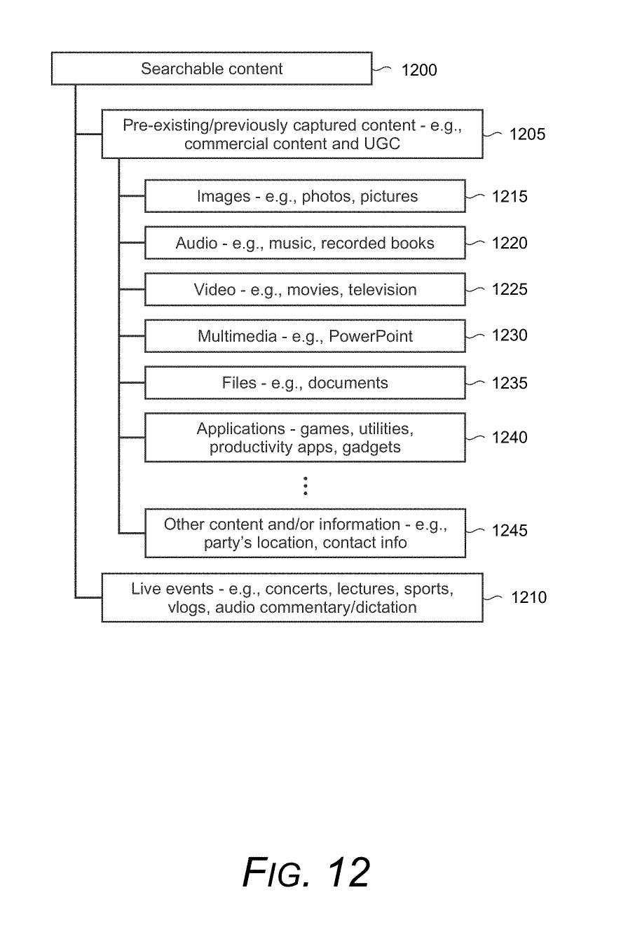

The digital assistant 612 can also employ a gesture recognition system 1005 having a UI as shown in FIG. 10. Here, the system 1005 can sense gestures 1010 performed by the user 605 as inputs to invoke various actions, features, and functions on a device 610, provide inputs to the systems and applications, and the like. The user gestures 1010 can be sensed using various techniques such as optical sensing, touch sensing, proximity sensing, and the like. In some cases, various combinations of voice commands, gestures, and physical manipulation of real or virtual controls can be utilized to interact with the digital assistant. In some scenarios, the digital assistant can be automatically invoked. For example, as the digital assistant typically maintains awareness of device state and other context, the digital assistant may be invoked by specific context such as user input, received notifications, or detected events.

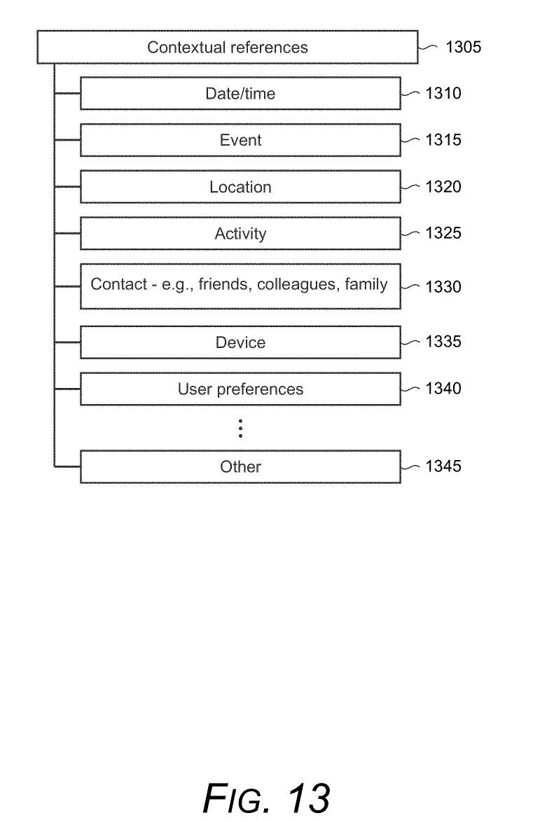

As shown in FIG. 11, the digital assistant may expose a tangible user interface 1105 that enables the user 605 to employ physical interactions 1110 in support of user experiences on the device 610. Such physical interactions can include manipulation of physical and/or virtual controls such as buttons, menus, keyboards, using touch-based inputs like tapping, flicking, or dragging on a touchscreen, and the like. The digital assistant may be configured to be launched from any location within any UI on the device, or from within any current user experience. For example, the user 605 can be on a phone call, browsing the web, watching a video, or listening to music, and simultaneously launch the digital assistant from within any of those experiences. In some cases the digital assistant can be launched through manipulation of a physical or virtual user control, and/or by voice command and/or gesture in other cases.

Various types of content can be searched using the present contextual search using natural language. The content can be provided and/or supported by the applications 640 (FIG. 6) and/or the service 645. FIG. 12 shows an illustrative taxonomy of searchable content 1200. It is noted that the searchable content can be stored locally on a device, or be stored remotely from the device but still be accessible to the device. For example, the searchable content can be stored in a cloud store, be available on a network such as a local area network, be accessed using a connection to another device, and the like.

As shown in FIG. 12, the searchable content 1200 can include both pre-existing and/or previously captured content 1205 (e.g., commercially available content and/or user-generated content (UGC)), as well as content 1210 associated with live events (e.g., concerts, lectures, sporting events, audio commentary/dictation, video logs (vlogs)). As shown, illustrative examples of existing and/or previously captured content 1205 include images 1215, audio 1220, video 1225, multimedia 1230, files 1235, applications 1240, and other content and/or information 1245. The shareable content shown in FIG. 12 is illustrative and not intended to be exhaustive. The types of content utilized can vary according the needs of a particular implementation.

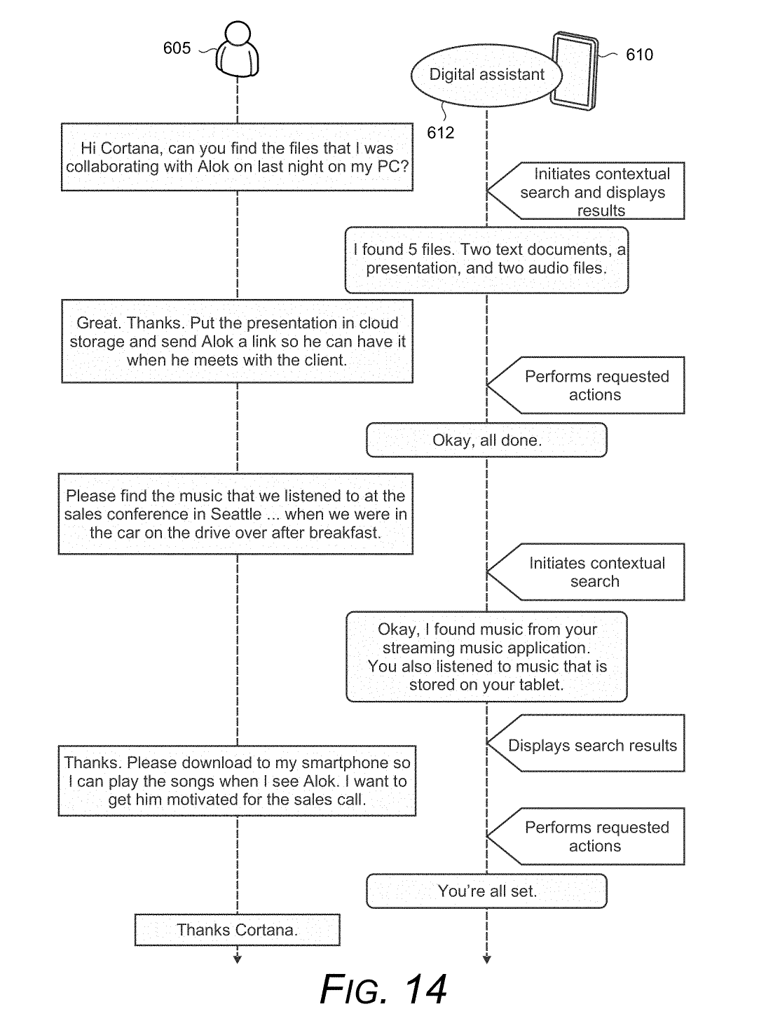

FIG. 13 shows illustrative contextual references 1305 that may be used when performing a contextual search. The contextual references 1305 may include date/time 1310, event 1315, location 1320, activity 1325, contact 1330, device 1335, user preferences 1340, or other references 1345 as may be needed for a particular implementation of contextual searching.

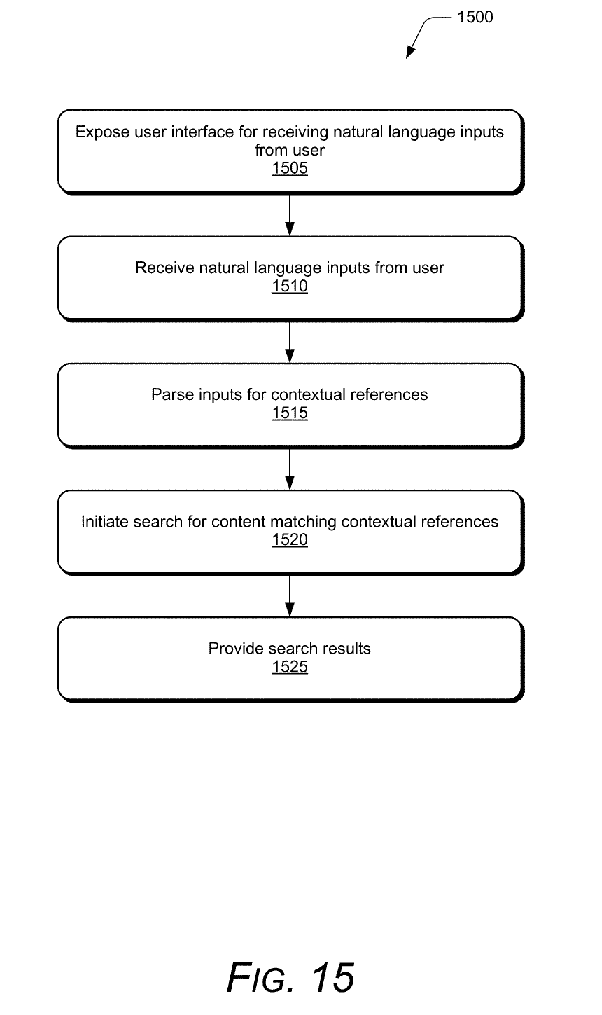

FIG. 14 shows an illustrative contextual search scenario in which the user 605 has interactions with the digital assistant 612 operating on device 610. In this illustrative scenario, the digital assistant is invoked by the name “Cortana.” The user first asks for a search for files that he previously worked on with a colleague. Here, the contextual references parsed out of the user's language by the digital assistant include date/time, contact, and device. The digital assistant responsively initiates a search using that context and presents the search results to the user. The user then asks for another search for music files. In this case, the contextual references include location and activity. Accordingly, the digital assistant can examine the user's calendar to determine when the user was at the particular location in order to find the requested content.

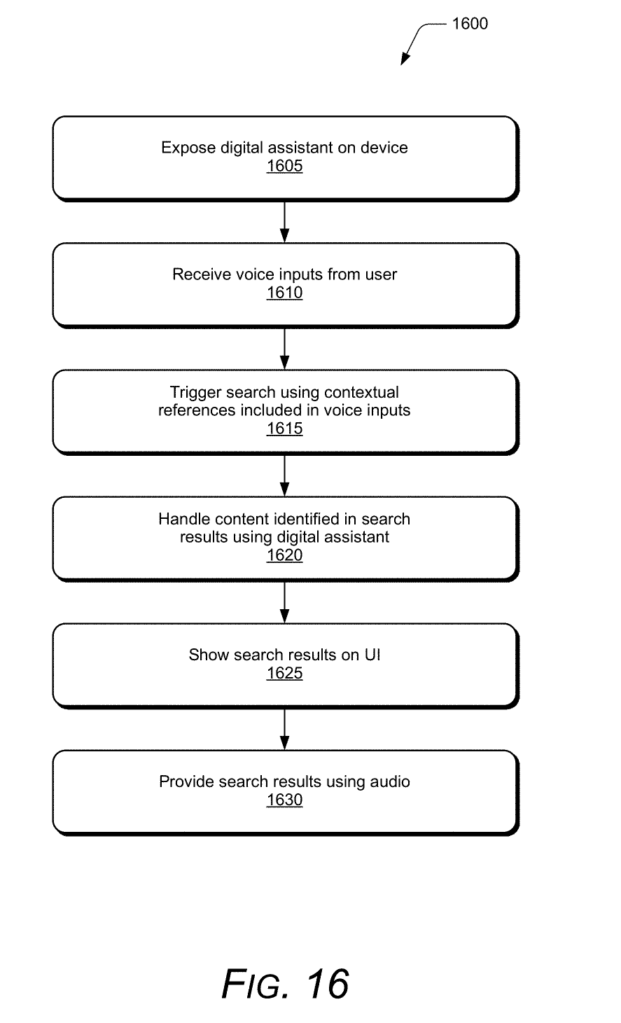

FIG. 15 shows a flowchart of an illustrative method 1500 for operating a digital assistant on a device. Unless specifically stated, the methods or steps shown in the flowcharts and described in the accompanying text are not constrained to a particular order or sequence. In addition, some of the methods or steps thereof can occur or be performed concurrently and not all the methods or steps have to be performed in a given implementation depending on the requirements of such implementation and some methods or steps may be optionally utilized.

In step 1505, the digital assistant exposes a user interface and receives natural language inputs from the user in step 1510. In step 1515, the inputs from the user are parsed to identify contextual references. The digital assistant can initiate a search for content that matches the contextual references in step 1520. The digital assistant provides search results in step 1525. The results can be rank ordered and display the appropriate contextual reference in some cases.

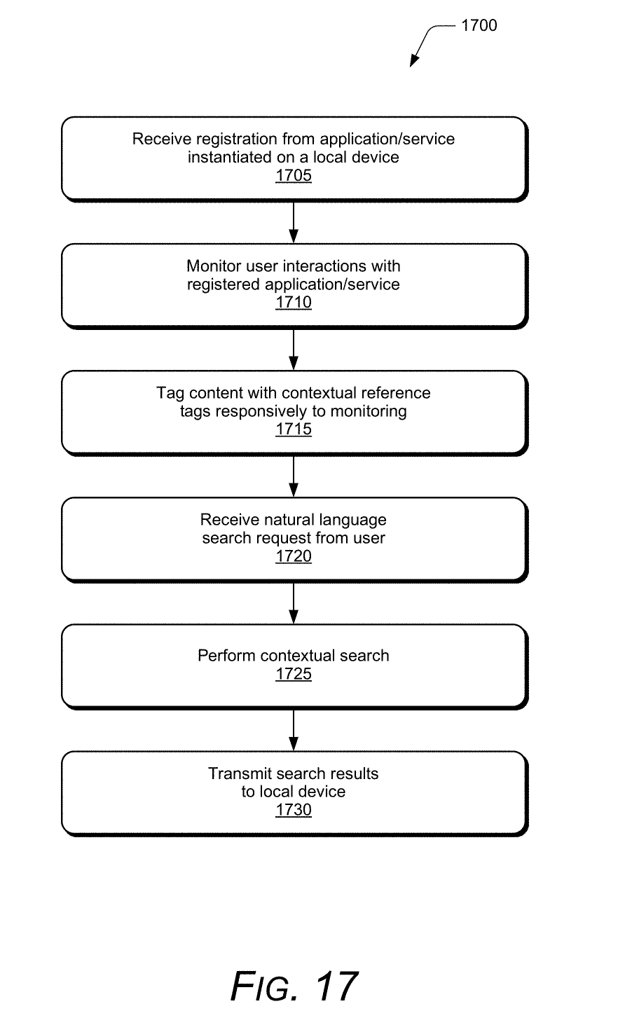

FIG. 16 shows a flowchart of an illustrative method 1600 that may be performed on a device that includes one or more processors, a UI, and a memory device storing computer-readable instructions. In step 1605, a digital assistant that is configured for voice interactions with a user using the UI is exposed. In step 1610, voice inputs from the user are received. A search using the contextual references from the voice inputs is triggered in step 1615. The digital assistant handles content identified in search results in step 1620. The search results are shown on the UI in step 1625 and the search results can be provided using audio in step 1630. The handling can take various suitable forms. For example, the digital assistant can fetch content for consumption, provide content or links to content to other users, devices, locations, application or services, store or copy content, manipulate or transform content, edit content, augment content, and the like. Such handling may also be responsive to interactions with the user over the UI, for example using a natural language interface or protocol.

FIG. 17 shows a flowchart of an illustrative method 1700 that may be performed by a service that supports a digital assistant. In step 1705, the service can receive registrations from applications and/or services that are instantiated on a device. User interactions with the registered applications and services are monitored in step 1710 (typically with notice to the user and with user consent). Content is tagged in step 1715 with contextual reference tags including one or more of time, date, event, location, schedule, activity, contact, or device. A search request from the user is received in step 1720 and a responsive search is performed in step 1725. Search results are transmitted to the device in step 1730.

Although embodiments of one step task completion have been described in language specific to features and/or methods, the appended claims are not necessarily limited to the specific features or methods described. Rather, the specific features and methods are disclosed as example implementations of one step task completion, and other equivalent features and methods are intended to be within the scope of the appended claims. Further, various different embodiments are described and it is to be appreciated that each described embodiment can be implemented independently or in connection with one or more other described embodiments. Additional aspects of the techniques, features, and/or methods discussed herein relate to one or more of the following embodiments.

A computing system implemented for one step task completion, the system comprising: memory configured to maintain metadata associated with information that corresponds to a user, the information being determinable with a contextual search based on the metadata; a processor system to implement a personal assistant application that is configured to: receive a request as a one step directive to locate the information and perform an action designated for the information; locate the information based on the metadata; and perform the action designated for the information.

Alternatively or in addition to the above described computing system, any one or combination of: the information that corresponds to the user is tagged with the metadata, providing a context of the information for the contextual search. The one step directive is a multi-part, single command comprising at least a first part to find the information and at least a second part to perform the action. The personal assistant application is configured to confirm the action of the one step directive having been performed for the information. The personal assistant application is configured to: receive the one step directive as a natural language input; and parse the natural language input to identify the requested information and the action to perform. The personal assistant application is configured to receive the one step directive as the natural language input in one of an audio format, a haptic format, a typed format, or a gesture format. The information that corresponds to the user is search content entered in a browser application; and the personal assistant application is configured to locate the search content and perform the action associated with the search content. The computing system includes: a user device comprising the memory that maintains the metadata and the information; and a cloud-based computer system comprising the personal assistant application configured to receive the one step directive from the user device. The information that corresponds to the user is maintained as third-party data, accessible from a social media site based on a user account; the personal assistant application is a cloud-based service application configured to: access the social media site utilizing the user account to said locate the information; and access the information to said perform the action designated for the information. The information that corresponds to the user is maintained as third-party data, accessible from a third-party data service based on a user account; and the personal assistant application is configured to: access the third-party data service utilizing the user account to said locate the information; and access the information to said perform the action designated for the information.

A method for one step task completion, the method comprising: receiving a request as a one step directive to locate information and perform an action designated for the information; locating the information based on metadata associated with the information; and performing the action designated for the information.

Alternatively or in addition to the above described method, any one or combination of: tagging the information corresponding to a user with the metadata, the information then determinable with a contextual search based on the metadata. The one step directive is a multi-part, single command comprising at least a first part to find the information and at least a second part to perform the action. Confirming the action of the one step directive having been performed for the information. Said receiving the one step directive as a natural language input in one of an audio format, a haptic format, a typed format, or a gesture format; and parsing the natural language input to identify the requested information and the action to perform. The information is search content entered in a browser application; and said locating the search content and said performing the action associated with the search content. The information is maintained as third-party data, accessible from a social media site based on a user account; and the method further comprising: accessing the social media site utilizing the user account to locate the information; and accessing the information to perform the action designated for the information. The information is maintained as third-party data, accessible from a third-party data service based on a user account; and the method further comprising: accessing the third-party data service utilizing the user account to locate the information; and accessing the information to perform the action designated for the information.

A computer-readable storage memory comprising a personal assistant application stored as instructions that are executable and, responsive to execution of the instructions by a computing device, performing operations comprising to: receive a request as a one step directive to locate information and perform an action associated with the information, the one step directive being received as a natural language input; locate the information with a contextual search based on metadata associated with the information; and perform the action designated for the information. Alternatively or in addition to the above described operations, the operations further comprise to: access a third-party data service utilizing a user account to said locate the information that is maintained as third-party data by the third-party data service; and access the information to said perform the action designated for the information.

1. A computing system implemented for one step task completion, the system comprising:
memory configured to maintain metadata associated with information that corresponds to a user, the information being determinable with a contextual search based on the metadata;
a processor system to implement a personal assistant application that is configured to:
receive a request as a one step directive to locate the information and perform an action designated for the information;
locate the information based on the metadata; and
perform the action designated for the information.

2. A computing system as recited in claim 1, wherein the information that corresponds to the user is tagged with the metadata, providing a context of the information for the contextual search.

3. A computing system as recited in claim 1, wherein the one step directive is a multi-part, single command comprising at least a first part to find the information and at least a second part to perform the action.

4. A computing system as recited in claim 1, wherein the personal assistant application is configured to confirm the action of the one step directive having been performed for the information.

5. A computing system as recited in claim 1, wherein the personal assistant application is configured to:
receive the one step directive as a natural language input; and
parse the natural language input to identify the requested information and the action to perform.

6. A computing system as recited in claim 5, wherein the personal assistant application is configured to receive the one step directive as the natural language input in one of an audio format, a haptic format, a typed format, or a gesture format.

7. A computing system as recited in claim 1, wherein:
the information that corresponds to the user is search content entered in a browser application; and
the personal assistant application is configured to locate the search content and perform the action associated with the search content.

8. A computing system as recited in claim 1, wherein the computing system includes:
a user device comprising the memory that maintains the metadata and the information; and
a cloud-based computer system comprising the personal assistant application configured to receive the one step directive from the user device.

9. A computing system as recited in claim 1, wherein:
the information that corresponds to the user is maintained as third-party data, accessible from a social media site based on a user account;
the personal assistant application is a cloud-based service application configured to:
access the social media site utilizing the user account to said locate the information; and
access the information to said perform the action designated for the information.

10. A computing system as recited in claim 1, wherein:
the information that corresponds to the user is maintained as third-party data, accessible from a third-party data service based on a user account; and
the personal assistant application is configured to:
access the third-party data service utilizing the user account to said locate the information; and
access the information to said perform the action designated for the information.

11. A method for one step task completion, the method comprising:
receiving a request as a one step directive to locate information and perform an action designated for the information;
locating the information based on metadata associated with the information; and
performing the action designated for the information.

12. The method as recited in claim 11, further comprising:
tagging the information corresponding to a user with the metadata, the information then determinable with a contextual search based on the metadata.

13. The method as recited in claim 11, wherein the one step directive is a multi-part, single command comprising at least a first part to find the information and at least a second part to perform the action.

14. The method as recited in claim 11, further comprising:
confirming the action of the one step directive having been performed for the information.

15. The method as recited in claim 11, further comprising:
said receiving the one step directive as a natural language input in one of an audio format, a haptic format, a typed format, or a gesture format; and
parsing the natural language input to identify the requested information and the action to perform.

16. The method as recited in claim 11, wherein:
the information is search content entered in a browser application; and
said locating the search content and said performing the action associated with the search content.

17. The method as recited in claim 11, wherein the information is maintained as third-party data, accessible from a social media site based on a user account; and the method further comprising:
accessing the social media site utilizing the user account to locate the information; and
accessing the information to perform the action designated for the information.

18. The method as recited in claim 11, wherein the information is maintained as third-party data, accessible from a third-party data service based on a user account; and the method further comprising:
accessing the third-party data service utilizing the user account to locate the information; and
accessing the information to perform the action designated for the information.

19. A computer-readable storage memory comprising a personal assistant application stored as instructions that are executable and, responsive to execution of the instructions by a computing device, performing operations comprising to:
receive a request as a one step directive to locate information and perform an action associated with the information, the one step directive being received as a natural language input;
locate the information with a contextual search based on metadata associated with the information; and
perform the action designated for the information.

20. The computer-readable storage memory as recited in claim 19, wherein the operations further comprise to:
access a third-party data service utilizing a user account to said locate the information that is maintained as third-party data by the third-party data service; and
access the information to said perform the action designated for the information.
